(19) United States
(12) Patent Application Publication
(10) Pub. No.: US 2007/0154739 A1
(43) Pub. Date: Jul. 5, 2007

(54) Coated cemented carbide inserts

(75) Inventors: Malin Martensson, Nacka (SE); Mats Ahlgren, Taby (SE); Anders Nordgren, Enskede (SE); Kerstin Wahlquist, Stockholm (SE); Maria Astrand, Sollentuna (SE)

Correspondence Address: DRINKER BIDDLE & REATH (DC), 1500 K STREET, N.W., SUITE 1100, WASHINGTON, DC, 20005-1209, US

(73) Assignee: SANDVIK INTELECTUAL PROPERTY AB

(21) Appl. No.: 11/637,218

(22) Filed: Dec. 12, 2006

(30) Foreign Application Priority Data
Dec. 14, 2005 (SE) 0502747-9

(51) Int. Cl. B32B 9/00; B32B 19/00; H05H 1/24

(52) U.S. Cl. 428/698; 427/569

(57) ABSTRACT

The present invention relates to a cutting insert particularly useful for turning in heat resistant super alloys and stainless steels comprising a substrate and a coating. The substrate comprises WC from about 5 to about 7 wt-% Co and from about 0.15 to about 0.60 wt-% TaC and from about 0.10 to about 0.50 wt-% NbC and balance WC, has a coercivity of from about 19.5 to about 24.5 kA/m and a CW-ratio between from about 0.85 to about 1.00. The coating comprises a homogeneous AlₓTi₁₋ₓN-layer with x=from about 0.6 to about 0.7 and a thickness of greater than about 1 μm but less than about 3.8 μm.

### BACKGROUND OF THE INVENTION

The present invention relates to a coated cutting tool insert particularly useful for turning of heat resistant super alloys and stainless steels. A thin PVD-coating greatly improves the flank wear resistance and the notch wear resistance both on the leading and secondary edge and a fine grained substrate provides good resistance against plastic deformation.

Turning of super alloys can generally be divided in roughing, semi-roughing, semi-finishing and finishing. In roughing and semi-roughing the depth of cut is larger than the nose radius and notch wear on both the leading and the secondary edge is the dominant wear mechanism. In semi-finishing and finishing, the depth of cut is smaller than the nose radius and the flank wear and crater wear dominate.

The wear of the secondary edges is an important parameter since it affects the quality of the machined surface.

### OBJECTS AND SUMMARY OF THE INVENTION

It is an object of the present invention to provide a cutting tool insert particularly useful for turning in heat resistant super alloys and stainless steels.

It is a further object of the present invention to provide a cutting tool insert with improved wear resistance of the secondary edge.

In one aspect of the invention, there is provided a cutting tool insert comprising a substrate and a coating wherein said substrate comprises from about to 5 to about 7 wt-% Co, from about 0.15 to about 0.60 wt-% TaC, from about 0.10 to about 0.50 wt-% NbC and balance WC, a coercivity of from about 19.5 to about 24.5 kA/m, a CW-ratio between from about 0.85 to about 1.00 and said coating comprises a homogeneous AlₓTi₁₋ₓN-layer with x=from about 0.6 to about 0.67 and a thickness of greater than about 1 μm, but less than about 3.8 μm.

In another aspect of the invention, there is provided a method of making a coated cutting tool insert of a cemented carbide substrate and a coating comprising producing the substrate using conventional powder metallurgical techniques of milling, pressing and sintering, the substrate comprising from about 5 to about 7 wt-% Co and from about 0.15 to about 0.60 wt-% TaC and from about 0.10 to about 0.50 wt-% NbC and balance WC with coercivity of from about 19.5 to about 24.5 kA/m and a CW-ratio between from about 0.85 to about 1.00 and after conventional post sintering treatment, depositing a coating comprising AlₓTi₁₋ₓN with x=from about 0.6 to about 0.67 by cathodic arc evaporation using a target material of a TiAl-alloy of suitable composition, in an N₂ gas atmosphere whereby the total thickness of the coating is greater than about 1 μm but less than about 3.8 μm.

In a still further aspect of the invention, there is the use of the insert described above for turning of heat resistant super alloys and stainless steels at a cutting speed of from about 30 to about 180 m/min and a feed of from about 0.1 to about 0.4 mm/rev.

### BRIEF DESCRIPTION OF THE DRAWINGS

FIG. 1 shows the wear on the secondary edge over time for inserts according to the invention (un-filled diamonds), outside invention (filled squares) and prior art (filled triangles).

### DETAILED DESCRIPTION OF THE PREFERRED EMBODIMENTS

It has now surprisingly been found that a relatively thin PVD-coating greatly improves the flank wear resistance and the notch wear resistance both on the leading and secondary edge and a fine grained substrate provides good resistance against plastic deformation when turning in heat resistant super alloys and stainless steels. The wear on the secondary cutting edge increases with coating thickness. When the coating thickness exceeds about 4 μm, the wear escalates on the secondary edge.

The present invention thus relates to a coated cutting tool insert of a cemented carbide substrate and a coating. The cemented carbide substrate comprises from about 5 to about 7 wt-% Co, preferably from about 5.8 to about 6.2 wt-% Co, most preferably about 6.0 wt-% Co and from about 0.15 to about 0.60 wt-% TaC, preferably from about 0.20 to about 0.30 wt-% TaC and from about 0.10 to about 0.50 wt-% NbC, preferably from about 0.10 to about 0.20 wt-% NbC and balance WC. The cemented carbide body may also contain smaller amounts of other elements, but then at a level corresponding to a technical impurity. The coercivity is from about 19.5 to about 24.5 kA/m.

The cobalt binder phase is alloyed with a certain amount of W giving the invented cemented carbide cutting insert its desired properties. W in the binder phase influences the magnetic properties of cobalt and can hence be related to a CW-ratio, defined as
CW=magnetic-% Co/wt-% Co
where magnetic-% Co is the weight percentage of magnetic Co and wt-% Co is the weight percentage of Co in the cemented carbide.

The CW-ratio can vary between 1 and about 0.75 dependent on the degree of W-alloying. A lower CW-ratio correspond to higher W contents and CW-ratio=1 corresponds practically to an absence of W in the binder phase.

It has been found according to the present invention that improved cutting performance is achieved if the cemented carbide body has a CW-ratio between from about 0.85 to about 1.00, preferably from about 0.9 to about 0.98, most preferably from about 0.92 to about 0.97.

The coating comprises a homogeneous coating AlₓTi₁₋ₓN with x=from about 0.6 to about 0.67, preferably x=about 0.62. The total thickness of the layer is greater than about 1 μm, preferably greater than about 1.8 μm but less than about 3.8 μm, preferably less than about 3.0 μm. Both the composition and the thickness are measured on the flank face 1 mm from the nose radius and 200 μm from the cutting edge.

The present invention also relates to a method of making a coated cutting tool insert consisting of a cemented carbide substrate and a coating. The cemented carbide substrate is made using conventional powder metallurgical techniques milling, pressing and sintering and consists of from about 5 to about 7 wt-% of Co, preferably from about 5.8 to about 6.2 wt-% Co, most preferably about 6.0 wt-% Co and from about 0.15 to about 0.60 wt-% TaC, more preferably from about 0.20 to about 0.30 wt-% TaC and from about 0.10 to about 0.50 wt-% NbC, preferably from about 0.10 to about 0.20 wt-% NbC and balance WC. The cemented carbide body may also contain smaller amounts of other elements, but then on a level corresponding to a technical impurity. The coercivity is from about 19.5 to about 24.5 kA/m.

The CW-ratio is between from about 0.85 to about 1.00, preferably from about 0.9 to about 0.98, most preferably from about 0.92 to about 0.97 and the CW-ratio is monitored by adding suitable amounts of carbon black or tungsten powder to the powder mixture.

After conventional post sintering treatment, e.g., blasting or grinding, a coating comprising AlₓTi₁₋ₓN with x=from about 0.6 to about 0.67, preferably x=about 0.62 is deposited by cathodic arc evaporation using a target material consisting of TiAl-alloy of suitable composition, in a N₂ gas atmosphere. The total thickness of the coating is greater than about 1 μm, preferably greater than about 1.8 μm but less than about 3.8 μm, preferably less than about 3.0 μm.

The present invention also relates to the use of the insert according to above for turning in heat resistant super alloys and stainless steels as Inconel 718, Inconel 625, Waspaloy, Udimet 720, San-Mac 316L, SAF2205, SAF2507 at a cutting speed of 30-180 m/min and a feed of from about 0.1 to about 0.4 mm/rev.

The invention is additionally illustrated in connection with the following examples, which are to be considered as illustrative of the present invention. It should be understood, however, that the invention is not limited to the specific details of the examples.

### EXAMPLE 1

A homogeneous (Ti,Al)N coating was deposited by cathodic arc evaporation on turning inserts made of cemented carbide with composition of 6 wt-% Co, 0.16 wt-% NbC, 0.23 wt-% TaC and balance WC and a coercivity of 22.4 kA/m and a CW-ratio of 0.96. The coating was deposited using a target material consisting of Ti₃₃Al₆₇ alloy. The arc evaporation was performed in a N₂ gas atmosphere. The resulting total coating thickness was 2.5 μm, and consisted of a homogeneous Al₆₂Ti₃₈N layer.

### EXAMPLE 2

Example 1 was repeated with the important difference that the deposition time was chosen to obtain a layer thickness of 4.5 μm.

### EXAMPLE 3

A. Cemented carbide turning inserts in accordance with the invention with the composition 6 wt-% Co, 0.16 wt-% NbC, 0.23 wt-% TaC and balance WC and a coercivity of 22.4 kA/m and with a binder phase alloyed with W corresponding to a CW-ratio of 0.96 were coated with a 2.9 μm (Ti,Al)N PVD-coating.

B. Commercial cemented carbide with the composition of 6 wt-% Co, 0.5 wt-% Cr₃C₂ and balance WC and with a coercivity of 23.8 kA/m and a CW-ratio of 0.85. The inserts were coated with a 2.9 μm (Ti,Al)N PVD-coating.

Inserts from A and B were tested in turning of a cast, Inconel 718 bearing house.

Operation: Turning/facing—roughing

Work-piece: Bearing house

Material: Inconel 718 in cast and aged condition

Cutting speed: 34 m/min

Feed rate: 0.175 mm/rev

Depth of cut: 1.78 mm

Insert-style: CNMG120408

Note: Turning with coolant

Results: Flank wear on secondary cutting edge after 7.2 minutes of machining

Grade A: (invention) 0.05 mm

Grade B: (prior art) 0.20 mm

Tool change after two components (pre-determined) corresponding to 7.2 minutes of machining.

### EXAMPLE 4

C. Commercial cemented carbide with the composition of 6 wt-% Co, 0.16 wt-% NbC, 0.23 wt-% TaC and balance WC with a coercivity of 23.1 kA/m and a CW-ratio of 0.93. The inserts were coated with a 4.3 μm PVD (Ti,Al)N multilayer coating.

Inserts from A and C were tested in turning of a Inconel 718 gate spring retainer.

Operation: Turning—roughing

Work-piece: Gate spring retainer

Material: Inconel 718 in forged and aged condition

Cutting speed: 30 m/min

Feed rate: 0.2 mm/rev

Depth of cut: 2.5 mm

Insert-style: CNMG120412

Note: Turning with coolant

Results: Flank wear along main cutting edge after one component

Grade A: (invention) 0.05 mm

Grade C: (prior art) 0.10 mm

Tool change after one component (pre-determined).

### EXAMPLE 5

D. Cemented carbide turning inserts in accordance with the invention with the composition 6 wt-% Co, 0.16 wt-% NbC, 0.23 wt-% TaC and balance WC and with a coercivity of 24.0 kA/m and a CW-ratio of 0.93 were coated with a 2.6 μm (Ti,Al)N PVD-coating.

E. Commercial cemented carbide with the composition of 6 wt-% Co, 0.5 wt-% Cr₃C₂ and balance WC and with a coercivity of 22.0 kA/m and a CW-ratio=0.82. The inserts were coated with a 5.2 μm (Ti,Al)N PVD-coating.

Inserts from D and E were tested in turning of a Udimet 720 turbine wheel.

Operation: Turning—semi-finishing

Work-piece: Turbine wheel

Material: Udimet 720 in forged and aged condition

Cutting speed: 46 m/min

Feed rate: 0.075-0.15 mm/rev

Depth of cut: 1 mm

Insert-style: CNGP 120408

Note: Turning with coolant

Results: Flank wear along secondary edge after one component

Grade D: (invention) 0.07 mm D

Grade E: (prior art) 0.13 mm

Tool change after one component (pre-determined) corresponding to 13 minutes of machining.

### EXAMPLE 6

Inserts from B, C and D were tested in turning of a Udimet 720 turbine wheel.

Operation: Turning—semi-finishing

Work-piece: Turbine wheel

Material: Udimet 720 in forged and aged condition

Cutting speed: 46-55 m/min

Feed rate: 0.075-0.125 mm/rev

Depth of cut: 0.25-1 mm

Insert-style: CNGP 120408, CNGG 120408

Note: Turning with coolant

Results: Flank wear along main cutting edge after one component

Grade D: (invention) 0.04 mm

Grade C: (prior art) 0.09 mm

Grade B: (prior art) 0.17 mm

Tool change after one component (pre-determined) corresponding to 23.7 minutes of machining.

### EXAMPLE 7

Inserts from B, D and E were tested in turning of a Udimet 720 turbine wheel.

Operation: Turning—finishing

Work-piece: Turbine wheel

Material: Udimet 720 in forged and aged condition

Cutting speed: 46 m/min

Feed rate: 0.125 mm/rev

Depth of cut: 0.38 mm

Insert-style: CNGP 120408, CNGG 120408

Note: Turning with coolant

Results: Flank wear along main cutting edge after one component

Grade D: (invention) 0.05 mm

Grade E: (prior art) 0.10 mm

Grade B: (prior art) 0.10 mm

Tool change after one component (pre-determined) corresponding to 5 minutes of machining.

### EXAMPLE 8

Inserts from C and D were tested in turning of a Inconel 718 bar.

Operation: Turning—roughing

Work-piece: Forged and machined bar

Material: Inconel 718 in forged and aged condition

Cutting speed: 50 m/min

Feed rate: 0.25 mm/rev

Depth of cut: 1 mm

Insert-style: CNMG 120408

Note: Turning with coolant

Results: Tool life, minutes of cut

Grade D: (invention) 5.2 min

Grade C: (prior art) 3 min

Tool-life criterion was notch wear on main cutting edge 0.3 mm

### EXAMPLE 9

F. Commercial cemented carbide with the composition of 5.8 wt-% Co, 0.5 wt-% Cr₃C₂ and balance WC and with a coercivity of 19.8 kA/m and a CW-ratio of 0.83. The inserts were coated with a 1.3 μm (Ti,Al)N PVD coating.

Inserts from D, E and F were tested in turning of a Udimet 720 turbine wheel.

Operation: Turning—finishing

Work-piece: Turbine wheel

Material: Udimet 720 in forged and aged condition

Cutting speed: 46 m/min

Feed rate: 0.15 mm/rev

Depth of cut: 0.1-0.5 mm

Insert-style: CNGP 120408, CNGG 120408

Note: Turning with coolant

Results: Flank wear along secondary edge after one component

Grade D: (invention) 0.07 mm

Grade E: (prior art) 0.15 mm

Grade F: (prior art) 0.15 mm

Tool change after one component (pre-determined) corresponding to 8.3 minutes of machining.

### EXAMPLE 10

G. Cemented carbide turning inserts in accordance with the invention with the composition of 6 wt-% Co, 0.16 wt-% NbC, 0.23 wt-% TaC and balance WC and a coercivity of 24.0 kA/m and a CW-ratio of 0.93 were coated with a 2.6 μm (Ti,Al)N PVD-coating.

Inserts from C, E and G were tested in turning of a Inconel 718 casing.

Operation: Turning—finishing

Work-piece: Casing

Material: Inconel 718 in forged and aged condition

Cutting speed: 37 m/min

Feed rate: 0.2 mm/rev

Depth of cut: 0.25 mm

Insert-style: CNMG 120408

Note: Turning with coolant

Results: Flank wear along secondary edge after one component

Grade G: (invention) 0.06 mm

Grade E: (prior art) 0.17 mm

Grade C: (prior art) 0.22 mm

Tool change after one component (pre-determined) corresponding to 9.7 minutes of machining.

### EXAMPLE 11

H. Cemented carbide turning inserts in accordance with the invention with the composition 6 wt-% Co, 0.16 wt-% NbC, 0.23 wt-% TaC and balance WC and with a coercivity of 21.6 kA/m and a CW-ratio of 0.95 were coated with a 2.7 μm (Ti,Al)N PVD-coating.

Inserts from C and H were tested in turning of an Inconel 718 bar.

Operation: Turning—semi-finishing

Work-piece: Forged and machined bar

Material: Inconel 718 in forged and aged condition

Cutting speed: 70 m/min

Feed rate: 0.15 mm/rev

Depth of cut: 0.5 mm

Insert-style: CNGP 120408

Note: Turning with coolant

Results: Tool life, minutes of cut

Grade H: (invention) 5 min

Grade C: (prior art) 2.5 min

Tool-life criterion was notch wear on main cutting edge 0.3 mm

### EXAMPLE 12

Cemented carbide turning inserts in accordance with the invention with the composition 6 wt-% Co, 0.16 wt-% NbC, 0.23 wt-% TaC and WC and average WC grain size of 1.2 μm, and with a coercivity of 22.0 kA/m and a CW-ratio of 0.97 were coated with a 2.4 μm thick (Ti,Al)N PVD-coating.

Inserts from B, C and I were tested in turning of an Inconel 718 bar.

Operation: Turning—roughing

Work-piece: Forged and machined bar

Material: Inconel 718 in forged and aged condition

Cutting speed: 50 m/min

Feed rate: 0.2 mm/rev

Depth of cut: 1.5 mm

Insert-style: CNMG 120408

Note: Turning with coolant

Results: Tool life, minutes of cut

Grade I: (invention) 5.5 min

Grade B: (prior art) 4.5 min

Grade C: (prior art) 3.2 min

Tool-life criterion was notch wear=0.3 mm on main cutting edge

### EXAMPLE 13

J. Cemented carbide turning inserts in accordance with the invention with the same composition as grade I but coated with a 4.7 μm thick (Ti,Al)N PVD-coating.

Inserts from Grade I (invention), Grade J and Grade C (prior art) were tested in turning of an Inconel 718 bar.

Operation: Turning—roughing

Work-piece: Forged and machined bar

Material: Inconel 718 in forged and aged condition

Cutting speed: 50 m/min

Feed rate: 0.2 mm/rev

Depth of cut: 1.5 mm

Insert-style: CNMG 120408

Note: Turning with coolant

Results: Flank wear on secondary cutting edge after 4 minutes of machining.

Grade I: (invention) 0.12 mm

Grade J: (outside invention) 0.26 mm

Grade C: (prior art) 0.26 mm

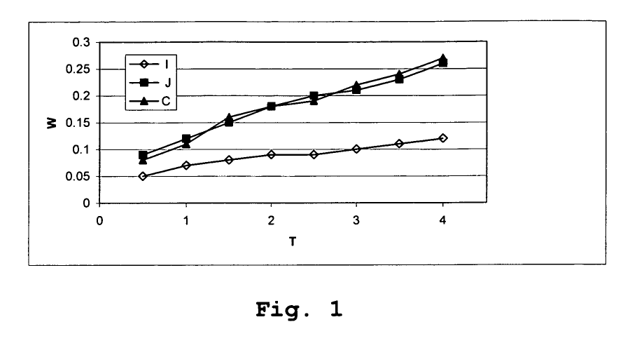

The diagram in FIG. 1 shows the maximum flank wear on the secondary edge over time, where W is the maximum wear on the secondary edge in mm and T is the time in cut in minutes. The unfilled diamonds denote grade I (invention), the filled squares denote grade J (outside invention) and the filled triangles denote grade C (prior art).

Although the present invention has been described in connection with preferred embodiments thereof, it will be appreciated by those skilled in the art that additions, deletions, modifications, and substitutions not specifically described may be made without department from the spirit and scope of the invention as defined in the appended claims.

1. Cutting tool insert comprising a substrate and a coating wherein:
said substrate comprises from about to 5 to about 7 wt-% Co, from about 0.15 to about 0.60 wt-% TaC, from about 0.10 to about 0.50 wt-% NbC and balance WC, a coercivity of from about 19.5 to about 24.5 kA/m, a CW-ratio between from about 0.85 to about 1.00 and said coating comprises a homogeneous AlₓTi₁₋ₓN-layer with x=from about 0.6 to about 0.67 and a thickness of greater than about 1 μm, but less than about 3.8 μm.

2. The cutting tool insert of claim 1 wherein said substrate comprises from about 5.8 to about 6.2 wt-% Co, from about 0.20 to about 0.30 wt-% TaC, from about 0.10 to about 0.20 wt-% NbC and has a CW-ratio of from about 0.9 to about 0.98.

3. The cutting tool insert of claim 1 wherein said substrate comprises about 6.0 wt-% Co and has a CW-ratio of from about 0.92 to about 0.97.

4. The cutting tool insert of claim 1 wherein in said coating x is about 0.62 and said layer has a thickness greater than about 1.8 μm but less than about 3.0 μm.

5. Method of making a coated cutting tool insert of a cemented carbide substrate and a coating comprising producing the substrate using conventional powder metallurgical techniques of milling, pressing and sintering, the substrate comprising from about 5 to about 7 wt-% Co and from about 0.15 to about 0.60 wt-% TaC and from about 0.10 to about 0.50 wt-% NbC and balance WC with coercivity of from about 19.5 to about 24.5 kA/m and a CW-ratio between from about 0.85 to about 1.00 and after conventional post sintering treatment, depositing a coating comprising AlₓT₁₋ₓN with x=from about 0.6 to about 0.67 by cathodic arc evaporation using a target material of a TiAl-alloy of suitable composition, in an N₂ gas atmosphere whereby the total thickness of the coating is greater than about 1 μm but less than about 3.8 μm.

6. The method of claim 5 wherein said substrate comprises from about 5.8 to about 6.2 wt-% Co, from about 0.20 to about 0.30 wt-% TaC, from about 0.10 to about 0.20 wt-% NbC and has a CW-ratio of from about 0.9 to about 0.98.

7. The method of claim 6 wherein said substrate comprises about 6.0 wt-% Co and has a CW-ratio of from about 0.92 to about 0.97.

8. The method of claim 5 wherein in said coating x is about 0.62 and said layer has a thickness greater than about 1.8 μm but less than about 3.0 μm.

9. Use of the insert of claim 1 for turning of heat resistant super alloys and stainless steels at a cutting speed of from about 30 to about 180 m/min and a feed of from about 0.1 to about 0.4 mm/rev.
